(19) United States
(12) Patent Application Publication
(10) Pub. No.: US 2022/0304383 A1
(43) Pub. Date: Sep. 29, 2022

(54) AN AEROSOL-GENERATING SYSTEM AND A CARTRIDGE FOR AN AEROSOL-GENERATING SYSTEM HAVING IMPROVED HEATING ASSEMBLY

(71) Applicant: Philip Morris Products S.A., Neuchatel (CH)

(72) Inventors: Guillaume FREDERICK, Neuchatel (CH); Ihar ZINOVIK (Deceased), (US)

(73) Assignee: Philip Morris Products S.A., Neuchatel (CH)

(21) Appl. No.: 17/622,528

(22) PCT Filed: Jun. 2, 2020
(86) PCT No.: PCT/EP2020/065164

§ 371 Date: Dec. 23, 2021

(30) Foreign Application Priority Data
Jun. 25, 2019 (EP) 19182416.8

(51) Int. Cl. A24F 40/44; A24F 40/10; A24F 40/42; A24F 40/46; H05B 3/18

(52) U.S. Cl. CPC A24F 40/44; A24F 40/10; A24F 40/42; A24F 40/46; H05B 3/18; H05B 2203/021

(57) ABSTRACT

A vapour-generating system is provided, including: a reservoir holding an aerosol-generating substrate; and a heating assembly, including a heating element, and a ceramic element including pores, one side of the ceramic element being in fluidic communication with the reservoir such that the pores receive the substrate from the reservoir by capillary action, an opposite side of the ceramic element being in thermal communication with the heating element, the heating element being encapsulated within an impermeable material so as to inhibit fluidic communication between it and the substrate, the impermeable material being in fluidic communication with the ceramic element, and the heating element being configured to heat the ceramic element having the substrate therein to generate a vapour. A method for generating a vapour is also provided.

The invention relates to an aerosol-generating system and a cartridge for an aerosol-generating system that is configured to heat a flowable aerosol-forming substrate to generate an aerosol. In particular the invention relates to a handheld aerosol-generating system configured to generate aerosol for user inhalation.

Flowable aerosol-forming substrates for use in certain aerosol-generating systems can contain a mixture of different components. For example, liquid aerosol-forming substrates for use in electronic cigarettes can include a mixture of nicotine and one or more aerosol formers, and optionally flavors or acidic substances for adjustment of the user's sensorial perception of the aerosol.

In some handheld aerosol-generating systems that generate an aerosol from a liquid aerosol-forming substrate, there can be some means of transporting the substrate into fluidic communication with an aerosol-generating element for aerosolisation, and also in order to replenish substrate that has been aerosolised by the aerosol-generating element. As such, both during use and storage, aerosol-forming substrate can be in fluidic communication with (e.g., can directly contact) the aerosol-generating element. Depending on the respective compositions of the substrate and the aerosol-generating element, interactions (such as chemical reactions) can occur as a result of such fluidic communication.

It would be desirable to provide an arrangement for an aerosol-generating system in which fluidic communication, and thus interactions such as chemical reactions, between an aerosol-forming substrate and an aerosol-generating element are inhibited.

In a first aspect of the invention there is provided a vapour-generating system, comprising:
a reservoir holding an aerosol-generating substrate; and
a heating assembly, comprising:
   a heating element; and
   a ceramic element comprising pores, one side of the ceramic element being in fluidic communication with the reservoir such that the pores receive the aerosol-generating substrate from the reservoir by capillary action, an opposite side of the ceramic element being in thermal communication with the heating element,
wherein the heating assembly is configured so as to inhibit fluidic communication between the heating element and the aerosol-generating substrate, and
wherein the heating element is configured to heat the ceramic element having the aerosol-generating substrate therein to generate a vapour.

Within a suitable portion or portions of the system, the vapour can condense into an aerosol for inhalation by a user.

Optionally, the ceramic element is planar. Additionally, or alternatively, the heating element optionally comprises a resistive heating element. Additionally, or alternatively, the heating assembly optionally further comprises an impermeable material. Optionally, the impermeable material substantially surrounds the resistive heating element and inhibits fluidic communication between the resistive heating element and the aerosol-generating substrate. In some configurations, optionally the impermeable material comprises ceramic or glass, although it should be appreciated that any suitable impermeable material can be used. In one configuration, the impermeable material optionally can comprise Al₂O₃ or AlN. Additionally, or alternatively, the impermeable material optionally is in fluidic communication with the ceramic element. Additionally, or alternatively, the impermeable material optionally touches the ceramic element. Additionally, or alternatively, the resistive heating element optionally comprises a metal. Additionally, or alternatively, the heating element optionally is bonded to the ceramic element. It should be appreciated that any such impermeable material can be provided to surround any other suitable heating element, such as an inductive heating element, and to inhibit fluidic communication between such heating element and the aerosol-generating substrate.

Advantageously, in non-limiting configurations in which the heating element comprises a metal or other element(s) with which the aerosol-generating substrate can interact, the impermeable material can inhibit fluidic communication (e.g., direct contact) between the metal and the aerosol-generating substrate and thus can inhibit interactions (e.g., chemical reactions) between the metal and one or more components of the aerosol-generating substrate. For example, metallic heating elements for use in electronic cigarettes can be made from or can include high resistivity complex alloys in order to reach a target resistance compatible with device electronics. In such systems, the pH of the aerosol-generating substrate can vary within a wide range, e.g., from pH 6 to pH 9, depending on the respective concentrations of components of the substrate (such as nicotine, flavour, or acidic additives). Fluidic communication between the metallic heating element and aerosol-generating substrate (particularly one that is acidic or basic) can cause metal to dissolve into the substrate or chemically react with one or more components of the substrate, which may alter properties of the substrate. Additionally, or alternatively, fluidic communication between the metallic heating element and aerosol-generating substrate can permit diffusion of the substrate over the surface of the metallic heating element via which the substrate can reach electrical connectors, potentially damaging such connectors and potentially rendering themunusable. In one exemplary configuration, the aerosol-generating substrate (e.g., liquid or gel) can be acidic, e.g., can have a pH below 7.0.

As such, it may be useful to reduce or inhibit fluidic communication, and thus any interactions, between aerosol-generating substrate and aerosol-generating elements, such as heating elements comprising a metal or other element(s) with which the aerosol-generating substrate can interact. In some configurations provided herein, a metal or other element(s) of an aerosol-generating element with which the aerosol-generating substrate can interact is completely fluidically isolated from the aerosol-generating substrate during both use and storage, for example by encapsulating such metal or other element(s) within an impermeable material. In other configurations, the heating element comprises a laser. Advantageously, the laser can be used to heat the aerosol-generating substrate without fluidically contacting the substrate, thus inhibiting potential interactions between elements of the laser and the substrate. Illustratively, as one option, the laser can be configured to heat the ceramic element using laser light, causing generation of a vapour. The laser can have any suitable configuration to sufficiently heat the ceramic element to generate a vapour from aerosol-generating substrate therein. For example, optionally, the laser light can have a power between about 1 W and 10 W. Additionally, or alternatively, the laser light optionally can have a wavelength between about 450 nm and 650 nm. Regardless of the particular configuration of the aerosol-generating element, e.g., heating element (such as a resistive heating element or a laser), configurations of the present invention can inhibit interaction between the aerosol-generating substrate and the aerosol-generating heating element, thus inhibiting alteration of substrate properties and inhibiting damage to any components (such as metal components) of the aerosol-generating element, or other components of the system, that otherwise can result from contact with the substrate. As such, user experience or the usable lifetime of the device can be improved. The present invention can be particularly beneficial where the aerosol-generating substrate (e.g., liquid or gel) is acidic.

As noted above, the heating assembly also can include a ceramic element comprising pores. Advantageously, the ceramic element can act as a capillary material that receives aerosol-forming substrate from a reservoir, and that can be heated by the aerosol-generating element so as to form a vapour. The ceramic element may include interstices or apertures that draw flowable aerosol-forming substrate into the ceramic element by capillary action. For example, the structure of the ceramic element can form or include a plurality of small bores or tubes, through which the aerosol-forming substrate can be transported by capillary action. Illustratively, the pores optionally can comprise a network of interconnected pores, optionally which pores have a mean diameter of about 1 μm to about 2 μm. Additionally, or alternatively, optionally the pores comprise apertures defined within the ceramic element. Additionally, or alternatively, the ceramic element optionally has a porosity of about 40% to 60%.

The ceramic element may comprise any suitable ceramic material or combination of materials at least one of which is or includes ceramic material. Examples of suitable materials that can be used in the ceramic element, in combination with the ceramic material, include a sponge or foam material, graphite-based materials in the form of fibres or sintered powders, foamed metal or plastics material, a fibrous material, for example made of spun or extruded fibres, such as cellulose acetate, polyester, or bonded polyolefin, polyethylene, terylene or polypropylene fibres, or nylon fibres. The ceramic material of the ceramic element can include, for example, ceramic-based materials in the form of fibres or sintered powders. In one configuration, the ceramic element optionally can comprise Al₂O₃ or AlN.

The ceramic element may have any suitable capillarity and porosity so as to be used with flowable aerosol-generating substrates having different physical or chemical properties than one another. The physical properties of the aerosol-forming substrate can include but are not limited to viscosity, surface tension, density, thermal conductivity, boiling point and vapour pressure, which allow the flowable aerosol-forming substrate to be transported into and through the ceramic element by capillary action.

Alternatively, or in addition, the reservoir holding the aerosol-generating substrate may contain a carrier material for holding the aerosol-forming substrate. The carrier material optionally may be or include a foam, a sponge, or a collection of fibres. The carrier material optionally may be formed from a polymer or co-polymer. In one embodiment, the carrier material is or includes a spun polymer. The aerosol-forming substrate may be released into the ceramic element during use. For example, the aerosol-forming substrate may be provided in a capsule that can be fluidically coupled to the ceramic element.

In some configurations, the present vapour-generating system optionally further comprises a cartridge and a mouthpiece couplable to the cartridge, the cartridge comprising at least one of the reservoir and the heating assembly. Additionally, or alternatively, the present vapour-generating system optionally further comprises a housing comprising an air inlet, an air outlet, and an airflow passage extending therebetween, wherein the vapour at least partially condenses into an aerosol within the airflow passage.

For example, in various configurations provided herein, the cartridge may comprise a housing having a connection end and a mouth end remote from the connection end, the connection end configured to connect to a control body of an aerosol-generating system. The heating assembly may be located fully within the cartridge, or located fully within the control body, or may be partially located within the cartridge and partially located within the control body. For example, the heating element (aerosol-generating element) may be located within the cartridge, or may be located within the control body, and the ceramic element independently may be located within the cartridge, or may be located within the control body. Optionally, the side of the ceramic element that is in fluidic communication may also be in fluidic communication with the airflow passage. Additionally, or alternatively, the the side of the ceramic element that is in fluidic communication may directly face the mouth end opening. Such an orientation of a planar aerosol-generating element allows for simple assembly of the cartridge during manufacture.

Electrical power may be delivered to the aerosol-generating element from the connected control body through the connection end of the housing. In some configurations, the aerosol-generating element optionally is closer to the connection end than to the mouth end opening. This allows for a simple and short electrical connection path between a power source in the control body and the aerosol-generating element.

The first and second sides of the aerosol-generating element (e.g., heating element) may be substantially planar. The aerosol-generating element may comprise a substantially flat heating element to allow for simple manufacture. Geometrically, the term “substantially flat” heating element is used to refer to a heating element that is in the form of a substantially two dimensional topological manifold. Thus, the substantially flat heating element extends in two dimensions along a surface substantially more than in a third dimension. In particular, the dimensions of the substantially flat heating element in the two dimensions within the surface is at least five times larger than in the third dimension, normal to the surface. An example of a substantially flat heating element is a structure between two substantially imaginary parallel surfaces, wherein the distance between these two imaginary surfaces is substantially smaller than the extension within the surfaces. In some embodiments, the substantially flat heating element is planar. In other embodiments, the substantially flat heating element is curved along one or more dimensions, for example forming a dome shape or bridge shape.

The heating element may comprise one or a plurality of electrically conductive filaments. The term “filament” refers to an electrical path arranged between two electrical contacts. A filament may arbitrarily branch off and diverge into several paths or filaments, respectively, or may converge from several electrical paths into one path. A filament may have a round, square, flat or any other form of cross-section. A filament may be arranged in a straight or curved manner.

The heating element may be or include an array of filaments or wires, for example arranged parallel to each other. In some configurations, the filaments or wires may form a mesh. The mesh may be woven or non-woven. The mesh may be formed using different types of weave or lattice structures. For example, a substantially flat heating element may be constructed from a wire that is formed into a wire mesh. Optionally, the mesh has a plain weave design. Optionally, the heating element includes a wire grill made from a mesh strip. However, it should be appreciated that any suitable configuration and material of the resistive heating element can be used.

For example, the heating element may include or be formed from any material with suitable electrical properties. Suitable materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, constantan, nickel-, cobalt-, chromium-, aluminum-, titanium-, zirconium-, hafnium-, niobium-, molybdenum-, tantalum-, tungsten-, tin-, gallium-, manganese- and iron-containing alloys, and super-alloys based on nickel, iron, cobalt, stainless steel, Timetal®, iron-aluminum based alloys and iron-manganese-aluminum based alloys. Timetal® is a registered trade mark of Titanium Metals Corporation. Exemplary materials are stainless steel and graphite, more preferably 300 series stainless steel like AISI 304, 316, 304L, 316L. Additionally, the heating element may comprise combinations of the above materials. For example, a combination of materials may be used to improve the control of the resistance of the heating element. For example, materials with a high intrinsic resistance may be combined with materials with a low intrinsic resistance. This may be advantageous if one of the materials is more beneficial from other perspectives, for example price, machinability or other physical and chemical parameters. Advantageously, a substantially flat filament arrangement with increased resistance reduces parasitic losses. Advantageously, high resistivity heaters allow more efficient use of battery energy.

In one nonlimiting configuration, the heating element includes or is made of wire. More preferably, the wire is made of metal, most preferably made of stainless steel. The electrical resistance of the mesh, array or fabric of electrically conductive filaments of the heating element may be between 0.3 Ohms and 4 Ohms. Optionally, the electrical resistance is equal or greater than 0.5 Ohms. Optionally, the electrical resistance of the mesh, array or fabric of electrically conductive filaments is between 0.6 Ohms and 0.8 Ohms, for example about 0.68 Ohms. The electrical resistance of the mesh, array or fabric of electrically conductive filaments optionally can be at least an order of magnitude, and optionally at least two orders of magnitude, greater than the electrical resistance of electrically conductive contact areas. This ensures that the heat generated by passing current through the heating element is localized to the mesh or array of electrically conductive filaments. It is advantageous to have a low overall resistance for the heating element if the system is powered by a battery. A low resistance, high current system allows for the delivery of high power to the heating element. This allows the heating element to heat the electrically conductive filaments to a desired temperature quickly.

The heater assembly further may comprise electrical contact portions electrically connected to the heating element. The electrical contact portions may be or include two electrically conductive contact pads. The electrically conductive contact pads may be positioned at an edge area of the heating element. Illustratively, the at least two electrically conductive contact pads may be positioned on extremities of the heating element. An electrically conductive contact pad may be fixed directly to electrically conductive filaments of the heating element. An electrically conductive contact pad may comprise a tin patch. Alternatively, an electrically conductive contact pad may be integral with the heating element.

In configurations including a housing, the contact portions may exposed through a connection end of the housing to allow for contact with electrical contact pins in a control body.

The reservoir may comprise a reservoir housing. The heating assembly or any suitable component thereof may be fixed to the reservoir housing. The reservoir housing may comprise a moulded component or mount, the moulded component or mount being moulded over the heating assembly. The moulded component or mount may cover all or a portion of the heating assembly and may partially or fully isolate electrical contact portions from one or both of the airflow passage and the aerosol-forming substrate. The moulded component or mount may comprise at least one wall forming part of the reservoir housing. The moulded component or mount may define a flow path from the reservoir to the ceramic element.

The housing may be formed form a mouldable plastics material, such as polypropylene (PP) or polyethylene terephthalate (PET). The housing may form a part or all of a wall of the reservoir. The housing and reservoir may be integrally formed. Alternatively the reservoir may be formed separately from the housing and assembled to the housing.

In configurations in which the present system includes a cartridge, the cartridge may comprise a removable mouthpiece through which aerosol may be drawn by a user. The removable mouthpiece may cover the mouth end opening. Alternatively the cartridge may be configured to allow a user to draw directly on the mouth end opening.

The cartridge may be refillable with flowable aerosol-forming substrate. Alternatively, the cartridge may be designed to be disposed of when the reservoir becomes empty of flowable aerosol-forming substrate.

In configurations in which the present system further includes a control body, the control body may comprise at least one electrical contact element configured to provide an electrical connection to the aerosol-generating element when the control body is connected to the cartridge. The electrical contact element optionally may be elongate. The electrical contact element optionally may be spring-loaded. The electrical contact element optionally may contact an electrical contact pad in the cartridge. Optionally, the control body may comprise a connecting portion for engagement with the connection end of the cartridge. Optionally, the control body may comprise a power supply. Optionally, The control body may comprise control circuitry configured to control a supply of power from the power supply to the aerosol-generating element.

The control circuitry optionally may comprise a microcontroller. The microcontroller is preferably a programmable microcontroller. The control circuitry may comprise further electronic components. The control circuitry may be configured to regulate a supply of power to the aerosol-generating element. Power may be supplied to the aerosol-generating element continuously following activation of the system or may be supplied intermittently, such as on a puff-by-puff basis. The power may be supplied to the aerosol-generating element in the form of pulses of electrical current.

The control body may comprise a power supply arranged to supply power to at least one of the control system and the aerosol-generating element. The aerosol-generating element may comprise an independent power supply. The aerosol-generating system may comprise a first power supply arranged to supply power to the control circuitry and a second power supply configured to supply power to the aerosol-generating element.

The power supply may be or include a DC power supply. The power supply may be or include a battery. The battery may be or include a lithium based battery, for example a lithium-cobalt, a lithium-iron-phosphate, a lithium titanate or a lithium-polymer battery. The battery may be or include a nickel-metal hydride battery or a nickel cadmium battery. The power supply may be or include another form of charge storage device such as a capacitor. Optionally, the power supply may require recharging and be configured for many cycles of charge and discharge. The power supply may have a capacity that allows for the storage of enough energy for one or more user experiences; for example, the power supply may have sufficient capacity to allow for the continuous generation of aerosol for a period of around six minutes, corresponding to the typical time taken to smoke a conventional cigarette, or for a period that is a multiple of six minutes. In another example, the power supply may have sufficient capacity to allow for a predetermined number of puffs or discrete activations of the heating assembly.

The aerosol-generating system may be or include a handheld aerosol-generating system. The handheld aerosol-generating system may be configured to allow a user to suck on a mouthpiece to draw an aerosol through the mouth end opening. The aerosol-generating system may have a size comparable to a conventional cigar or cigarette. The aerosol-generating system optionally may have a total length between about 30 mm and about 150 mm. The aerosol-generating system may have an external diameter between about 5 mm and about 30 mm.

Optionally, the housing may be elongate. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. The material may be light and non-brittle.

The cartridge, control body or aerosol-generating system may comprise a puff detector in communication with the control circuitry. The puff detector may be configured to detect when a user draws through the airflow passage. Additionally, or alternatively, the cartridge, control body or aerosol-generating system may comprise a temperature sensor in communication with the control circuitry. The cartridge, control body or aerosol-generating system may comprise a user input, such as a switch or button. The user input may enable a user to turn the system on and off. Additionally, or alternatively, the cartridge, control body or aerosol-generating system optionally may comprise indication means for indicating the determined amount of flowable aerosol-forming substrate held in the reservoir to a user. The control circuitry may be configured to activate the indication means after a determination of the amount of flowable aerosol-forming substrate held in the reservoir has been made. The indication means optionally may comprise one or more of lights, such as light emitting diodes (LEDs), a display, such as an LCD display and audible indication means, such as a loudspeaker or buzzer and vibrating means. The control circuitry may be configured to light one or more of the lights, display an amount on the display, emit sounds via the loudspeaker or buzzer and vibrate the vibrating means.

The reservoir may hold a flowable aerosol-forming substrate, such as a liquid or gel. As used herein, an aerosol-forming substrate is a substrate capable of releasing volatile compounds that can form an aerosol. Volatile compounds may be released by heating the aerosol-forming substrate to form a vapour. The vapour can condense to form an aerosol. The flowable aerosol-forming substrate may be or include liquid at room temperature. The flowable aerosol-forming substrate may comprise both liquid and solid components. The flowable aerosol-forming substrate may comprise nicotine. The nicotine containing flowable aerosol-forming substrate may be or include a nicotine salt matrix. The flowable aerosol-forming substrate may comprise plant-based material. The flowable aerosol-forming substrate may comprise tobacco. The flowable aerosol-forming substrate may comprise a tobacco-containing material containing volatile tobacco flavour compounds, which are released from the aerosol-forming substrate upon heating. The flowable aerosol-forming substrate may comprise homogenised tobacco material. The flowable aerosol-forming substrate may comprise a non-tobacco-containing material. The flowable aerosol-forming substrate may comprise homogenised plant-based material.

The flowable aerosol-forming substrate may comprise one or more aerosol-formers. An aerosol-former is any suitable known compound or mixture of compounds that, in use, facilitates formation of a dense and stable aerosol and that is substantially resistant to thermal degradation at the temperature of operation of the system. Examples of suitable aerosol formers include glycerine and propylene glycol. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. The flowable aerosol-forming substrate may comprise water, solvents, ethanol, plant extracts and natural or artificial flavours.

The flowable aerosol-forming substrate may comprise nicotine and at least one aerosol former. The aerosol former may be glycerine or propylene glycol. The aerosol former may comprise both glycerine and propylene glycol. The flowable aerosol-forming substrate may have a nicotine concentration of between about 0.5% and about 10%, for example about 2%.

In a second aspect of the invention, there is provided a method for generating a vapour, the method comprising:
holding, by a reservoir, an aerosol-generating substrate;
inhibiting fluidic communication between a heating element and the aerosol-generating substrate;
receiving, by pores of a ceramic element in fluidic communication with the reservoir and in thermal communication with the heating element, the aerosol-generating substrate by capillary action;
heating, by the heating element, the ceramic element having the aerosol-generating substrate within the pores thereof to generate a vapour.

Features of the system of the first aspect of the invention may be applied to the second aspect of the invention.

Configurations of the invention will now be described in detail, by way of example only, with reference to the accompanying drawings, in which:

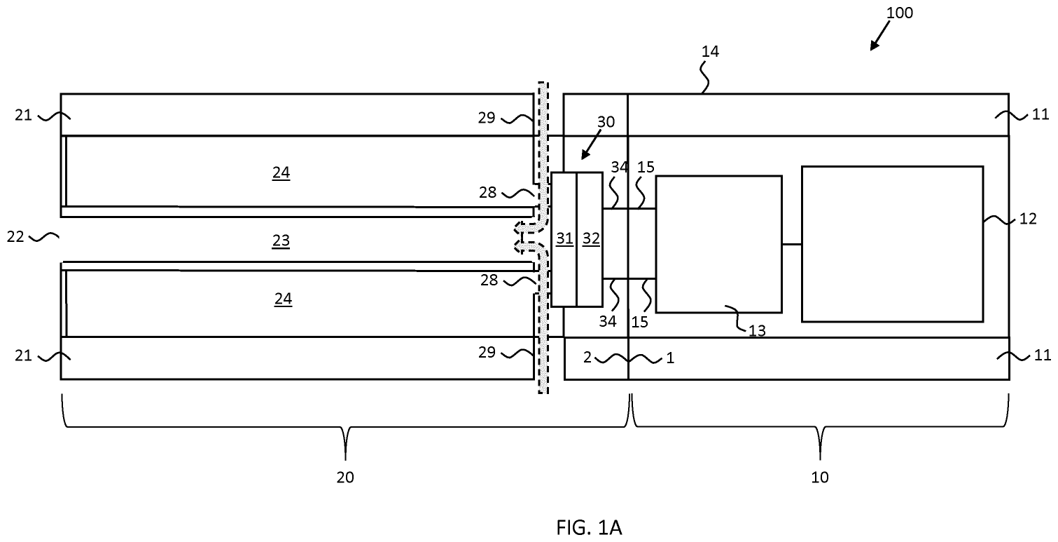

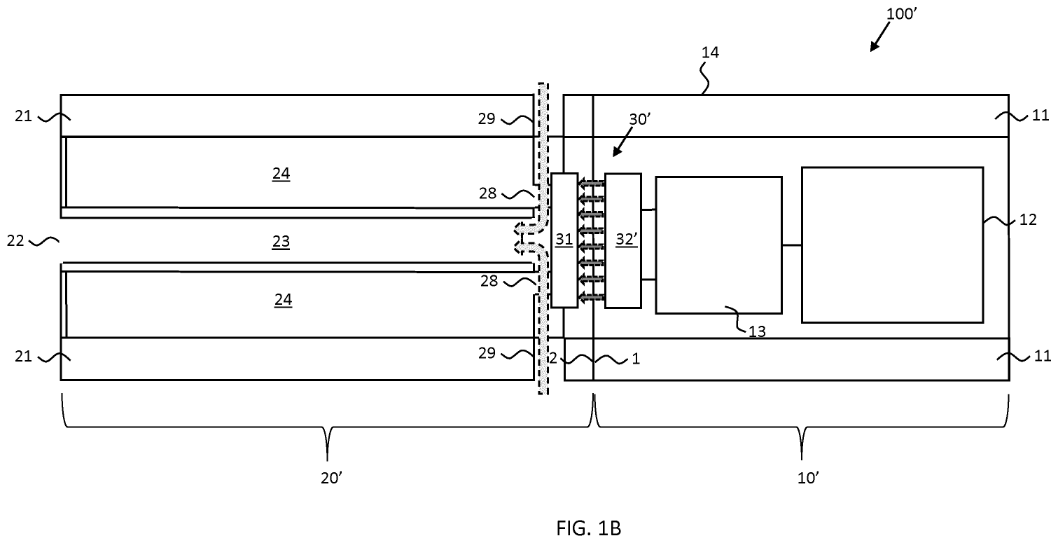

FIG. 1A is a schematic illustration of an aerosol-generating system in accordance with the invention;

FIG. 1B is a schematic illustration of another aerosol-generating system in accordance with the invention;

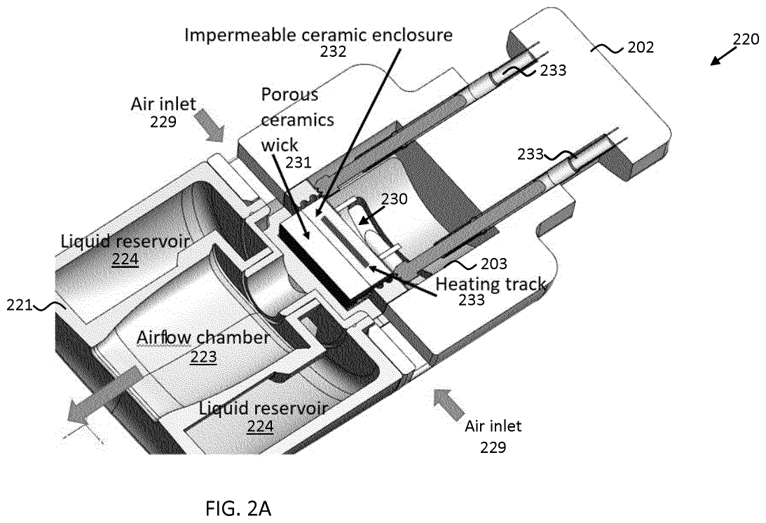

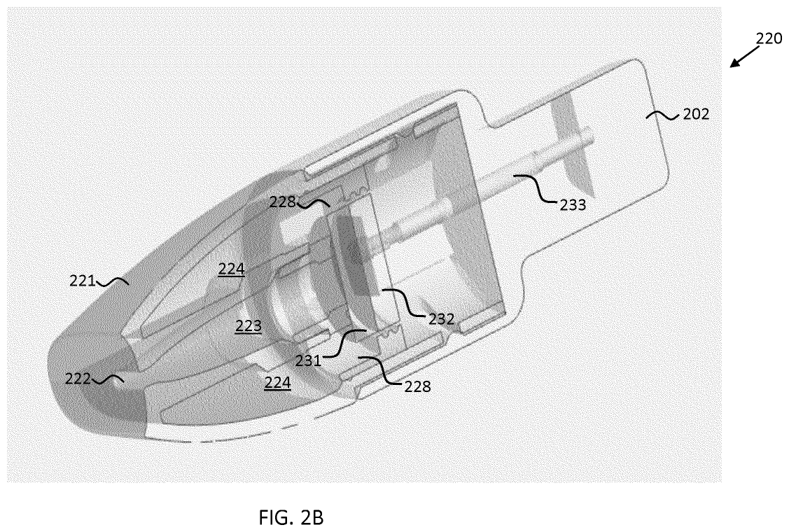

FIG. 2A is a schematic illustration of a first cross-section of a cartridge, in accordance with the invention;

FIG. 2B is a schematic illustration of a second cross-section of a cartridge in accordance with the invention;

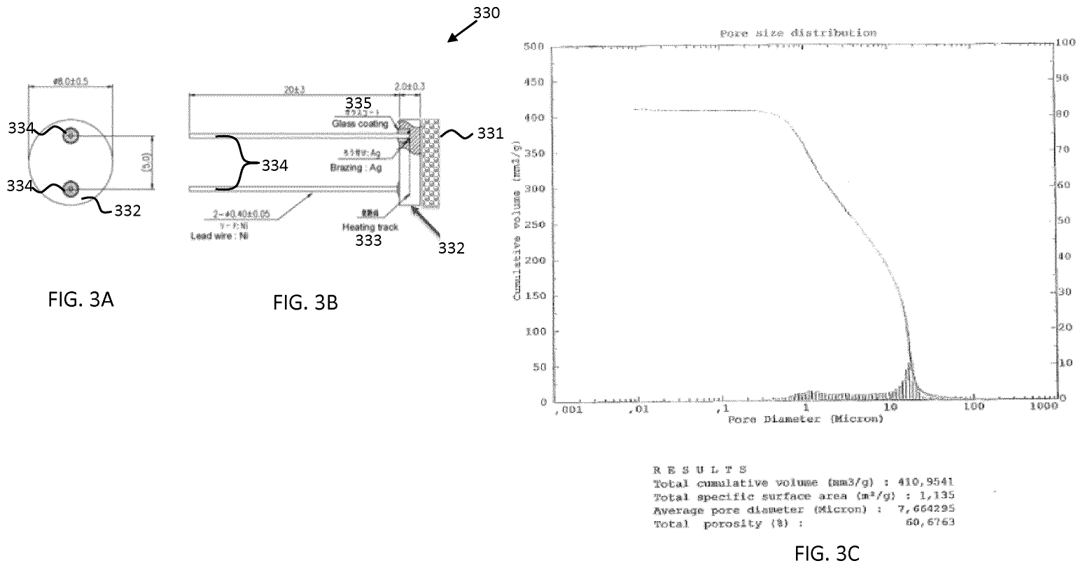

FIGS. 3A and 3B illustrate views of an exemplary heating assembly, in accordance with the invention;

FIG. 3C illustrates a plot of characteristics of various configurations of a porous ceramic element, in accordance with the invention;

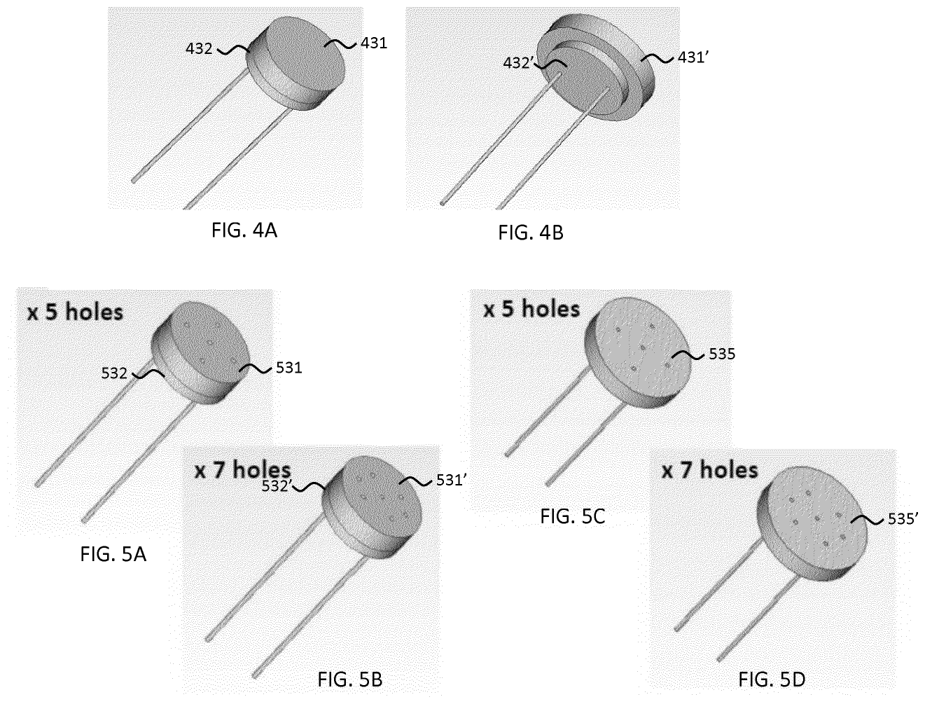

FIGS. 4A and 4B illustrate views of other exemplary heating assemblies, in accordance with the invention;

FIGS. 5A-5D illustrate views of still other exemplary heating assemblies, in accordance with the invention; and

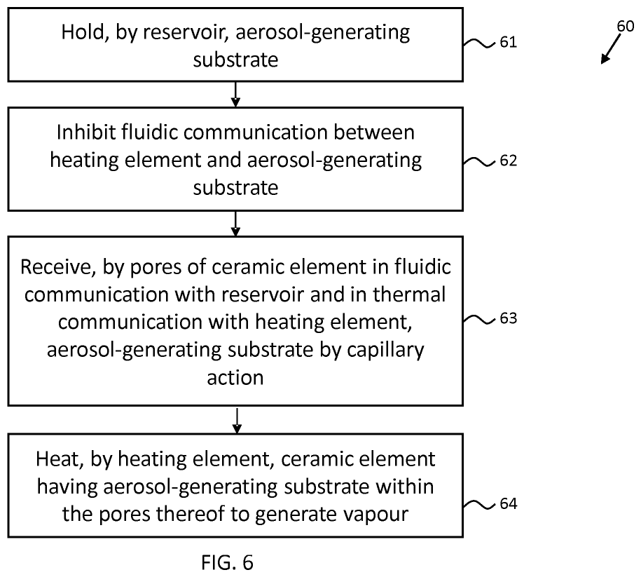

FIG. 6 illustrates a flow of operations in an exemplary method, in accordance with the invention.

FIG. 1A is a schematic illustration of an aerosol-generating system (vapour-generating system) 100 in accordance with the invention. The system 100 comprises two main components, a cartridge 20 and a control body 10. A connection end 2 of the cartridge 20 is removably connected to a corresponding connection end 1 of the control body 10. The control body 10 contains a battery 12, which in this example is a rechargeable lithium ion battery, and control circuitry 13. The aerosol-generating system 100 is portable and can have a size comparable to a conventional cigar or cigarette.

The cartridge 20 comprises a housing 21 containing a heating assembly 30 and a reservoir 24. A flowable aerosol-forming substrate is held in the reservoir 24. The upper portion of reservoir 24 is connected to the lower portion of the reservoir 24 illustrated in FIG. 1A. The heating assembly 30 receives substrate from reservoir 24 and heats the substrate to generate a vapour. More specifically, heating assembly 30 includes ceramic element 31 comprising pores, and heating element 32. One side of ceramic element 31 is in fluidic communication with reservoir 24 (for example, via fluidic channels 28) such that the pores receive the aerosol-generating substrate from reservoir 24 by capillary action. An opposite side of ceramic element 31 is in thermal communication with heating element 32. Optionally, ceramic element 31 is planar. The heating assembly 30 is configured so as to inhibit fluidic communication between heating element 32 and the aerosol-generating substrate. The heating element 32 is configured to heat the ceramic element 31 having the aerosol-generating substrate therein to generate a vapour.

In the illustrated configuration, an air flow passage 23 extends through the cartridge 20 from air inlet 29 past the heating assembly 30, through a passageway 23 through reservoir 24 to a mouth end opening 22 in the cartridge housing 21. The system 100 is configured so that a user can puff or suck on the mouth end opening 22 of the cartridge 20 to draw aerosol into their mouth. In operation, when a user puffs on the mouth end opening 22, air is drawn into and through the airflow passage 23 from the air inlet 29 and past the heating assembly 30 as illustrated in dashed arrows in FIG. 1A, and to the mouth end opening 22. The control circuitry 13 controls the supply of electrical power from the battery 12 to the cartridge 20 via electrical interconnects 15 (in control body 10) coupled to electrical interconnects 34 (in cartridge 20) when the system is activated. This in turn controls the amount and properties of the vapour produced by the heating assembly 30. The control circuitry 13 may include an airflow sensor and the control circuitry 13 may supply electrical power to the heating assembly 30 when the user puffs on the cartridge 20 as detected by the airflow sensor. This type of control arrangement is well established in aerosol-generating systems such as inhalers and e-cigarettes. So when a user sucks on the mouth end opening 22 of the cartridge 20, the heating assembly 30 is activated and generates a vapour that is entrained in the air flow passing through the air flow passage 23. The vapour at least partially cools within the airflow passage 23 to form an aerosol, which is then drawn into the user's mouth through the mouth end opening 22.

In some configurations, heater 32 optionally comprises a resistive heating element and an impermeable material. The impermeable material may substantially surround the resistive heating element and may inhibit fluidic communication between the resistive heating element and the aerosol-generating substrate. For example, the impermeable material may inhibit direct contact between the resistive heating element and the aerosol-generating substrate, and thus inhibit interactions (such as chemical reactions) between the resistive heating element and the aerosol-generating element. Exemplary configurations of heating assemblies that include ceramic elements, resistive heating elements, and impermeable materials are described elsewhere herein, e.g., with reference to FIGS. 3A-5D. For example, optionally the impermeable material can include ceramic or glass. Additionally, or alternatively, the resistive heating element optionally can include a metal. Additionally, or alternatively, the impermeable material can be in fluidic communication with ceramic element 31, and optionally can touch the ceramic element 31. Additionally, or alternatively, heating element 32 optionally can be bonded to ceramic element 31.

Alternatively, FIG. 1B is a schematic illustration of another aerosol-generating system 100′ that includes an alternative heating assembly 30′ including ceramic element 31 and alternative heating element 32′. In the configuration illustrated in FIG. 1B, heating element 32′ includes a laser that heats ceramic element 31 so as to generate a vapour from aerosol-generating substrate within the ceramic element. Preferably, the laser generates laser light at a wavelength and at a power sufficient to volatilise the aerosol-generating substrate within the ceramic element, e.g., a power between about 1 W and 10 W or a wavelength between about 450 nm and 650 nm. Specific exemplary wavelengths that the laser may generate are 532 nm, 450 nm, or 650 nm. Other portions of alternative system 100′ may be configured similarly as described elsewhere herein.

It will be appreciated that the heating element and ceramic element respectively and independently can be located in any suitable part of system 100 or system 100′ and in any suitable locations relative to one another. For example, in configurations such as illustrated in FIG. 1A, heating element 32 can be in direct contact with ceramic element 31, whereas in configurations such as illustrated in FIG. 1B, heating element 32′ can be spaced apart from ceramic element 31. As another example, in configurations such as illustrated in FIG. 1A, both heating element 32 and ceramic element 31 can be located within cartridge 20, whereas in configurations such as illustrated in FIG. 1B, heating element 32′ can be located within control body 10′ and ceramic element 31 can be located within cartridge 20′. In still other configurations (not specifically illustrated), the heating element and the ceramic element both can be located within the control body, or the heating element can be located within the cartridge and the ceramic element can be located within the control body. Independently of the respective part of the system in which the ceramic element and heater are located, the ceramic element and heater suitably can be in direct contact with one another or can be spaced apart from one another.

FIG. 2A is a first cross section of a cartridge in accordance with an embodiment of the invention. FIG. 2B is a second cross section, orthogonal to the cross section of FIG. 2a. The cartridge illustrated in FIGS. 2A-2B suitable can be used as cartridge 20 illustrated in FIG. 1A, and suitable can be modified for use as cartridge 20′ illustrated in FIG. 1B.

The cartridge 220 of FIGS. 2A-2B comprises an external housing 221 having a mouth end with a mouth end opening 222, and a connection end 202 opposite the mouth end. Within the housing 221 is reservoir (e.g., liquid reservoir) 224 holding a flowable aerosol-forming substrate. A heater assembly 230 is held in the heater mount 203. A ceramic element comprising pores (porous ceramics wick) 231 abuts a heating element comprising a heating track 233 and impermeable ceramic closure 232 in a central region of the heater assembly 230. The ceramic element 231 is oriented to transport flowable aerosol-generating substrate to the heating element 232, 233. Optionally, the heating track 233 comprises a mesh heater element, formed from a plurality of filaments. Details of this type of heater element construction can be found in WO2015/117702 for example. An airflow passage (airflow chamber) 223 extends from air inlets 229, past ceramic element 231 at which vapour becomes entrained within the airflow, and through the reservoir 224.

The heating element 232, 233 and ceramic element 231 each is generally planar. A first face of the ceramic element 231 faces and is in fluidic communication with the reservoir 224 via fluidic channels 228. A second face of the ceramic element 231 touches, and optionally is bonded to, impermeable ceramic closure 232. Optionally, the heater assembly 230 is closer to the connection end 202 so that electrical connection of the heater assembly 230 to a power supply can be easily and robustly achieved.

FIGS. 3A-3B illustrate views of an exemplary heating assembly 330 that can be included, for example, in system 100 illustrated in FIG. 1A or in cartridge 220 illustrated in FIGS. 2A-2B. Heating assembly 330 includes ceramic element 331 including pores, heating track (resistive heating element) 333, impermeable material 332 substantially surrounding the heating track 333, and electrical interconnects 334 configured to connect to electrical interconnects 15 within control body 10 in a manner such as illustrated in FIGS. 1A-1B. Additionally, impermeable material 332 substantially surrounds ends of electrical interconnects 334 where they contact heating track 333. In the configuration illustrated in FIGS. 3A-3B, ceramic element 331 touches and is bonded to impermeable material 332. During use, the pores of ceramic element 331 receive flowable aerosol-generating substrate from reservoir 24 or 224 by capillary action, and impermeable material 332 inhibits fluidic communication between heating track 333 and the aerosol-generating substrate, thus inhibiting interaction between any material(s) of heating track 333 and any components of the substrate. Responsive to power received from control body 10 via electrical interconnects 334, heating track 333 heats impermeable material 332 which in turn heats ceramic element 331 via direct thermal contact, generating a vapour from the aerosol-generating substrate within the pores of ceramic element 331.

Ceramic element 331, impermeable material 332, heating track 333, and electrical interconnects independently can include any suitable materials or combinations of materials and any suitable configuration so as to permit heating track 333 to sufficiently heat ceramic element 331 to generate a vapour while inhibiting fluidic communication between heating track 333 and the aerosol-generating substrate. For example, ceramic element 331 optionally can include a porous ceramic such as Al₂O₃ or AlN. Additionally, or alternatively, ceramic element 331 optionally can have a porosity of 40-60%. Additionally, or alternatively, ceramic element 331 optionally can have a mean pore diameter of 1-2 μm. Additionally, or alternatively, impermeable material 332 can include a non-porous ceramic, such as Al₂O₃ or AlN. Additionally, or alternatively, impermeable material 332 can include a glass. In one exemplary configuration, impermeable material 332 includes a non-porous ceramic that encapsulates heating track 333, and a glass that encapsulates the ends of electrical contracts 334. Additionally, or alternatively, heating track 333 can include a metal, such as tungsten (W). In some configurations, ceramic element 331 and impermeable material 332 can be bonded together, e.g., glued to one another using a heat resistive inorganic compound that includes or is composed of one or more of Al₂O₃, Zr based additives, SiO2, and Si salts.

Additionally, the pores of ceramic element 331 can have any suitable configuration. For example, the pores optionally can include a network of interconnected pores or can include apertures defined within the ceramic element, or can include both such a network and such apertures. FIG. 3C illustrates a plot of characteristics of various configurations of a porous ceramic element composed of Al₂O₃. For example, FIG. 3C illustrates a plot of cumulative volume and relative pore volume of ceramic element 331 as a function of pore diameter and pore size distribution.

FIGS. 4A-4B and 5A-5D illustrate views of other exemplary heating assemblies that can be included, for example, in system 100 illustrated in FIG. 1A or in cartridge 220 illustrated in FIGS. 2A-2B. In FIG. 4A, the pores of ceramic element 431 can include a network of interconnected pores, and heating element 432 can have the same outer diameter as ceramic element 431 (in one nonlimiting configuration, 8 mm) and a smaller thickness (e.g., 1 mm) than that of ceramic element 431 (e.g., 2 mm). In FIG. 4B, the pores of ceramic element 431′ can include a network of interconnected pores, and heating element 432′ can have the same outer diameter as ceramic element 431′ (in one nonlimiting configuration, 8 mm) and a smaller thickness (e.g., 1 mm) than that of ceramic element 431′ (e.g., 2 mm). In FIG. 5A, the pores of ceramic element 531 can include apertures (e.g., five holes) defined in the ceramic element, and heating element 532 can have the same outer diameter as ceramic element 531 (in one nonlimiting configuration, 8 mm) and a smaller thickness (e.g., 1 mm) than that of ceramic element 531 (e.g., 2 mm). In FIG. 5B, the pores of ceramic element 531′ can include apertures (e.g., seven holes) defined in the ceramic element, and heating element 532′ can have the same outer diameter as ceramic element 531′ (in one nonlimiting configuration, 8 mm) and a smaller thickness (e.g., 1 mm) than that of ceramic element 531′ (e.g., 2 mm). In FIG. 5C, the pores of ceramic element 535 can include apertures (e.g., five holes) defined in the ceramic element, and the heating element (not shown in FIG. 5C) can have a smaller outer diameter (e.g., 8 mm) than that of ceramic element 535 (e.g., 11 mm) and a smaller thickness (e.g., 1 mm) than that of ceramic element 535 (e.g., 2 mm). In FIG. 5D, the pores of ceramic element 535′ can include apertures (e.g., seven holes) defined in the ceramic element, and the heating element (not shown in FIG. 5D) can have a smaller outer diameter (e.g., 8 mm) than that of ceramic element 535′ (e.g., 11 mm) and a smaller thickness (e.g., 1 mm) than that of ceramic element 535′ (e.g., 2 mm). It should be appreciated that the present ceramic elements and heating elements can have any suitable size and number and type of pores.

Additionally, it should be appreciated that ceramic elements such as described with reference to FIGS. 3A-5D, or such as described elsewhere herein, suitably can be used together with heating elements other than resistive heating elements encapsulated by impermeable materials, e.g., can be used together with laser based heating elements such as described with reference to FIG. 1B and elsewhere herein.

An exemplary flow of operation of system 100, 100′ will now be briefly described. The system is first switched on using a switch on the control body 10 (not shown in FIGS. 1A-1B). The system may comprise an airflow sensor in fluid communication with the airflow passage can be puff activated. This means that the control circuitry 13 is configured to supply power to the heating assembly 30, 30′ based on signals from the airflow sensor. When the user wants to inhale aerosol, the user puffs on the mouth end opening 22 of the system. Alternatively the supply of power to the heating assembly 30, 30′ may be based on user actuation of a switch. When power is supplied to the heating assembly 30, 30′, the heating element 32, 32′ heats to temperature at or above a vaporisation temperature of the flowable aerosol-forming substrate. The aerosol-forming substrate within the pores of ceramic 31 is thereby vapourised and escapes into the airflow passage 23. The mixture of air drawn in through the air inlet 29 and the vapour from the ceramic 31 is drawn through the airflow passage 23 towards the mouth end opening 22. As it travels through the airflow passage 23 the vapour at least partially cools to form an aerosol, which is then drawn into the user's mouth. At the end of the user puff or after a set time period, power to the heating assembly 30, 30′ is cut and the heater cools again before the next puff.

FIG. 6 illustrates a flow of operations in an exemplary method 600. Although the operations of method 600 are described with reference to elements of systems 100, 100′, it should be appreciated that the operations can be implemented by any other suitably configured systems.

Method 600 includes holding, by a reservoir, an aerosol-generating substrate (61). For example, the aerosol-generating substrate can be or include a liquid or a gel, and can be held within a reservoir configured similarly to reservoir 24 illustrated in FIGS. 1A-1B or a reservoir configured similarly to reservoir 224 illustrated in FIGS. 2A-2B.

Method 600 illustrated in FIG. 6 includes inhibiting fluidic communication between a heating element and an aerosol-generating substrate (62). For example, the heating element can be substantially surrounded by an impermeable material in a manner such as described with reference to heating element 32 of FIG. 1A, heating track 233 of FIGS. 2A-2B, heating track 333 of FIGS. 3A-3B, or the heating element of FIGS. 4A-5D. Or, for example, the heating element can be suitably separated (e.g., spaced apart) from a ceramic element that receives the aerosol-generating substrate, for example as described with reference to heating element 32′ of FIG. 1B.

Method 600 illustrated in FIG. 6 also includes receiving, by pores of a ceramic element in fluidic communication with the reservoir and in thermal communication with the heating element, the aerosol-generating substrate by capillary action (63). For example, the ceramic element can be in fluidic communication with the reservoir via fluidic channels in a manner such as described with reference to ceramic element 31 or 31′, reservoir 24, and fluidic channels 28 of FIGS. 1A-1B or in a manner such as described with reference to ceramic element 231, reservoir 224, and fluidic channels 228 of FIGS. 2A-2B. Additionally, or alternatively, the ceramic element can be in thermal communication with the heating element in a manner such as described with reference to ceramic element 31 and heating element 32 of FIG. 1A, or in a manner such as described with reference to ceramic element 31′ and heating element 32′ of FIG. 1B, or in a manner such as described with reference to ceramic element 231 and heating element 232, 233 of FIGS. 2A-2B. The ceramic element can have any suitable configuration of pores that can draw and receive the aerosol-generating substrate by capillary action, for example such as described with reference to FIGS. 3A-3C, 4A-4B, or 5A-5D.

Method 600 illustrated in FIG. 6 also includes heating, by the heating element, the ceramic element having the aerosol-generating substrate within the pores thereof to generate a vapour (64). For example, the heating element suitably can heat the ceramic element to generate a vapour in a manner such as described with reference to ceramic element 31 and heating element 32 of FIG. 1A, or in a manner such as described with reference to ceramic element 31′ and heating element 32′ of FIG. 1B, or in a manner such as described with reference to ceramic element 231 and heating element 232, 233 of FIGS. 2A-2B. The vapour thus formed can condense into an aerosol.

Although some configurations of the invention have been described in relation to a system comprising a control body and a separate but connectable cartridge, it should be clear that the elements suitably can be provided in a one-piece aerosol-generating system.

It should also be clear that alternative geometries are possible within the scope of the invention. In particular, the cartridge and control body and any components thereof may have a different shape and configuration.

An aerosol-generating system having the construction described has several advantages. The possibility of interactions (such as chemical reactions) between the aerosol-generating substrate and materials of the heating element can be inhibited by inhibiting fluidic communication between the two. The possibility of aerosol-generating substrate damaging or corroding materials in the system is significantly reduced. The construction is robust and inexpensive and can inhibit alteration of aerosol-generating substrate or degradation of the system.

1.-18. (canceled)

19. A vapour-generating system, comprising:
a reservoir holding an aerosol-generating substrate; and
a heating assembly, comprising:
a heating element, and
a ceramic element comprising pores, one side of the ceramic element being in fluidic communication with the reservoir such that the pores receive the aerosol-generating substrate from the reservoir by capillary action, an opposite side of the ceramic element being in thermal communication with the heating element,
wherein the heating element of the heating assembly is encapsulated within an impermeable material so as to inhibit fluidic communication between the heating element and the aerosol-generating substrate,
wherein the impermeable material is in fluidic communication with the ceramic element, and
wherein the heating element is configured to heat the ceramic element having the aerosol-generating substrate therein to generate a vapour.

20. The vapour-generating system according to claim 19, wherein the heating element comprises a resistive heating element.

21. The vapour-generating system according to claim 20, wherein the heating assembly further comprises the impermeable material substantially surrounding the resistive heating element and inhibiting fluidic communication between the resistive heating element and the aerosol-generating substrate.

22. The vapour-generating system according to claim 20, wherein the resistive heating element comprises a metal.

23. The vapour-generating system according to claim 19, wherein the impermeable material comprises ceramic or glass.

24. The vapour-generating system according to claim 19, wherein the impermeable material touches or is bonded to the ceramic element.

25. The vapour-generating system according to claim 19, wherein the heating element comprises a laser configured to heat the ceramic element using laser light.

26. The vapour-generating system according to claim 25, wherein the laser light has a power between about 1 W and 10 W.

27. The vapour-generating system according to claim 25, wherein the laser light has a wavelength between about 450 nm and 650 nm.

28. The vapour-generating system according to claim 19, wherein the pores comprise a network of interconnected pores.

29. The vapour-generating system according to claim 19, wherein the ceramic element comprises Al₂O₃ or AlN.

30. The vapour-generating system according to claim 19, wherein the ceramic element has a porosity of about 40% to 60%.

31. The vapour-generating system according to claim 19, wherein the pores have a mean diameter of about 1 μm to about 2 μm.

32. The vapour-generating system according to claim 19, wherein the pores comprise apertures defined within the ceramic element.

33. The vapour-generating system according to claim 19, wherein the aerosol-generating substrate comprises nicotine.

34. The vapour-generating system according to claim 19, further comprising a cartridge and a mouthpiece couplable to the cartridge, the cartridge comprising at least one of the reservoir and the heating assembly.

35. The vapour-generating system according to claim 34,
wherein the cartridge further comprises a housing comprising an air inlet, an air outlet, and an airflow passage extending therebetween, and
wherein the vapour at least partially condenses into an aerosol within the airflow passage.

36. A method for generating a vapour, the method comprising:
holding, by a reservoir, an aerosol-generating substrate;
encapsulating a heating element within an impermeable material so as to inhibit fluidic communication between the heating element and the aerosol-generating substrate;
receiving, by pores of a ceramic element in fluidic communication with the reservoir and in thermal communication with the heating element, the aerosol-generating substrate by capillary action; and
heating, by the heating element, the ceramic element having the aerosol-generating substrate within the pores thereof to generate a vapour,
wherein the impermeable material is in fluidic communication with the ceramic element.
